(19) United States
(12) Patent Application Publication
(10) Pub. No.: US 2009/0179363 A1
(43) Pub. Date: Jul. 16, 2009

(54) Transmission mechanism for clamping device

(76) Inventor: Ferng-Jong Liou, Taichung (TW)

Correspondence Address: BACON & THOMAS, PLLC, 625 SLATERS LANE, FOURTH FLOOR, ALEXANDRIA, VA, 22314-1176, US

(21) Appl. No.: 12/007,882

(22) Filed: Jan. 16, 2008

(51) Int. Cl. B25B 1/02

(52) U.S. Cl. 269/6

(57) ABSTRACT

A transmission mechanism for clamping device includes a first set of four push members located behind an operating handle, and a second and a third set of two push members located behind a release trigger. The first set of push members is pushed by a first compression spring into an inclined position for firmly pressing against a scaled rod. A specially designed plastic cushion is disposed between the second and the third set of push members, so that the second and third sets of push members are rearward and forward inclined, respectively, under a forward push force from a second compression spring for respectively firmly pressing against lower and upper sides of a scaled rod at the same time. Meanwhile, when the operating handle is pulled, the force applied via the operating handle and transmitted to the first set of four push members is optimally buffered.

### FIELD OF THE INVENTION

The present invention relates to a transmission mechanism for clamping device, and more particularly to a transmission mechanism for clamping device that includes four inclined front push members behind an operating handle to buffer the applied force transmitted to the push members, and another four inclined rear push members behind a release trigger to firmly press against upper and lower sides of a scaled rod of the clamping device at the same time.

### BACKGROUND OF THE INVENTION

FIG. 1 shows a conventional clamping device generally available in the markets. The conventional clamping device includes a transmission mechanism in which an operating handle A is pivotally turned to incline a push member E behind the operating handle A. When the push member E is inclined, an opening B thereof engaging with a scaled rod D of the clamping device also inclines to firmly contact with, press against, and push the scaled rod D, which is fixedly connected to a movable jaw C of the clamping device, so that the scaled rod D, and accordingly the movable jaw C, are shifted.

A disadvantage of the above-described transmission mechanism for the conventional clamping device is that there is only one single push member E provided behind the operating handle A, and that the push member E tends to become loosened from the scaled rod D at the opening B when an overly large force is applied on the push member E via the operating handle A. The conventional clamping device also requires an operator to hold and operate the device laboriously to cause a sore and tired hand easily.

To overcome the above-mentioned disadvantage, a transmission mechanism for clamping device was developed by the same inventor and granted a U.S. Pat. No. 6,655,670. It is known the clamping force applied via the operating handle of the clamping device is the same as the total force transmitted to and distributed over the push member(s) assembled to the scaled rod of the clamping device. For example, when the applied clamping force is 100 kg, and there is only one push member, then the applied force transmitted to the one single push member is also 100 kg. In this case, an operator has to laboriously pull the operating handle, and the applied force is not necessary sufficient to stably clamp a workpiece. When there are two push members assembled to the scaled rod of the clamping device, as the case disclosed in the above-mentioned U.S. Pat. No. 6,655,670, the applied force transmitted to each of the two push members is 50 kg. When there are four push members provided on the scaled rod of the clamping device, the applied force transmitted to each of the four push members is 25 kg.

While the clamping device with two push members provided thereon enables an operator to operate the clamping device more easily, the applied force is still overly concentrated on the two push members to possibly result in unevenness on upper and lower surfaces of the scaled rod, preventing the scaled rod to smoothly slide to and fro.

After further research and development, an even improved transmission mechanism for clamping device is developed by the inventor.

### SUMMARY OF THE INVENTION

A primary object of the present invention is to provide an improved transmission mechanism for clamping device, so that the push members on the clamping device are not subject to the risk of loosening from the scaled rod when a large force is applied via the operating handle and transmitted to the push members, and an operator may operate the clamping device with largely reduced efforts.

To achieve the above and other objects, the transmission mechanism for clamping device according to the present invention includes a first set of four push members located behind an operating handle, and a second and a third set of two push members located behind a release trigger. The first set of push members is pushed by a first compression spring to incline forward for firmly pressing against a scaled rod. A specially designed plastic cushion is disposed between the second and the third set of push members, so that the second and third sets of push members being pushed by a second compression spring are inclined rearward and forward, respectively, to firmly press against upper and lower sides of the scaled rod, respectively. Meanwhile, with the above arrangements, when the operating handle is pulled to apply a clamping force, the applied force transmitted to the first set of four push members is buffered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially sectioned side view of a conventional clamping device showing a transmission mechanism thereof;

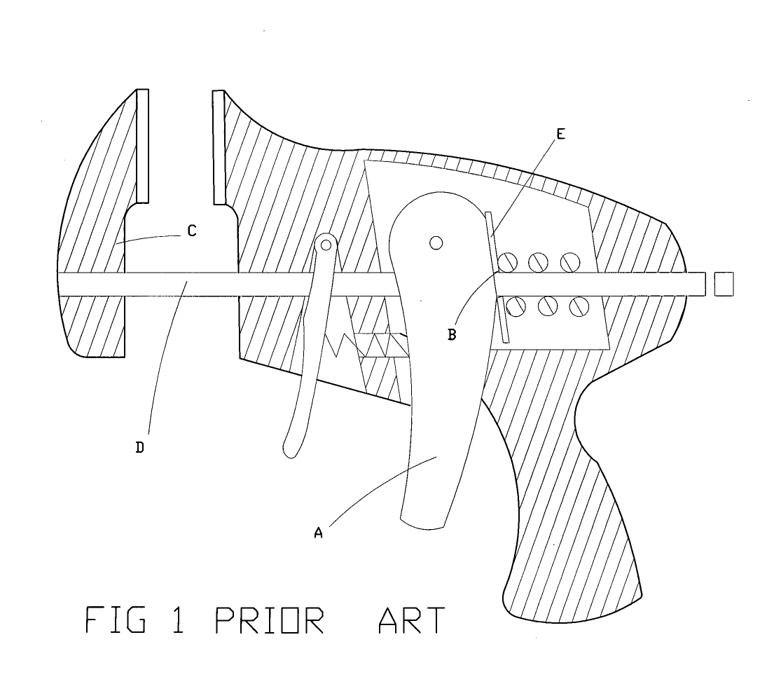

FIG. 2 is a partially sectioned side view showing a transmission mechanism for a clamping device according to the present invention;

FIGS. 3 and 4 are fragmentary, enlarged, and partially sectioned side views showing the positional relation between an operating handle, a first set of four push members, a scaled rod, and a first compression spring included in the present invention; and

FIGS. 5 and 6 are fragmentary, enlarged, and partially sectioned side views showing the positional relation between a release trigger, a second and a third set of two push members, the scaled rod, and a second compression spring included in the present invention.

### DETAILED DESCRIPTION OF THE PREFERRED EMBODIMENTS

From experiments and tests, it is proven that when a clamping device has four push members provided behind the operating handle thereof, the force applied via the operating handle is optimally buffered when it is transmitted to the four push members. It is also found from experiments and tests that when two sets of push members are provided behind a release trigger of the clamping device to respectively firmly press against upper and lower sides of the scaled rod of the clamping device, the clamping device would be more stable for use.

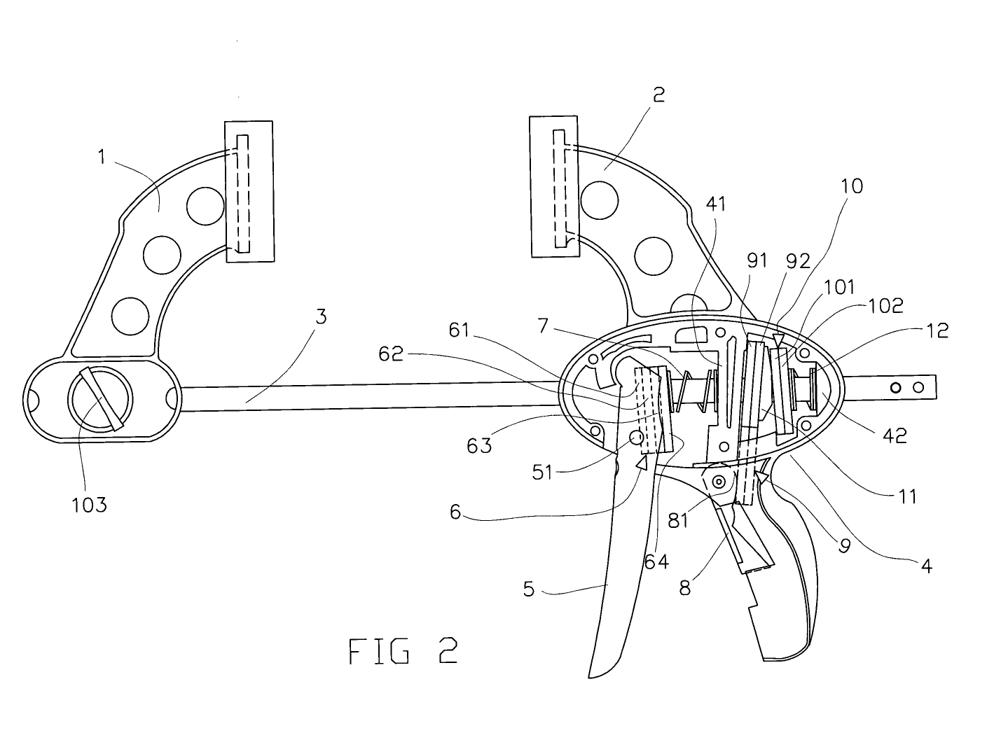

Please refer to FIG. 2, in which a transmission mechanism for clamping device according to the present invention is shown. The clamping device includes a movable jaw 1, a fixed jaw 2, a scaled rod 3, a housing 4, and a transmission mechanism. The transmission mechanism for the clamping device includes an operating handle 5, a first set of push members 6, a first compression spring 7, a release trigger 8, a second set of push members 9, a third set of push members 10, a plastic cushion 11, and a second compression 12.

The movable jaw 1 is fastened to a free end of the scaled rod 3 using a screw nut 103, so that the movable jaw 1 is movable along with the scaled rod 3 and cooperates with the fixed jaw 2 to clamp a workpiece (not shown) therebetween. The operating handle 5, the first set of push members 6, and the first compression spring 7 are mounted in a front side of the housing 4, while the release trigger 8, the second and the third set of push members 9, 10, the plastic cushion 11, and the second compression spring 12 are mounted in a rear side of the housing 4.

Please refer to FIG. 2. The operating handle 5 and the first set of push members 6 are each provided with a through opening, via which the scaled rod 3 is extended to assemble to the operating handle 5 and the push members 6. The first set of push members 6 is located behind the operating handle 5, and the first compression spring 7 is mounted around the scaled rod 3 with two ends separately pressed against a rear side of the first set of push members 6 and a front rib portion 41 in the housing 4. The operating handle 5 is provided at a predetermined position with a connecting link 51, which is in contact with a front side of the first set of push members 6, and the first compression spring 7 normally compresses against the rear side of the first set of push members 6, such that the first set of push members 6 is forward inclined, bringing the through openings 60 thereof to incline and thereby firmly press against the scaled rod 3. Whereby, when the operating handle 5 is pulled backward to shift the first set of push members 6, the scaled rod 3 and accordingly, the movable jaw 1 fastened to the free end of the scaled rod 3 are brought to shift synchronously.

The release trigger 8, the second and the third set of push members 9, 10, and the plastic cushion 11 are each provided with a through opening, via which the scaled rod 3 is extended to assemble to the release trigger 8, the second and the third set of push members 9, 10, and the plastic cushion 11. The second set of push members 9 is located behind the release trigger 8, and the second compression spring 12 is mounted around the scaled rod 3 with two ends separately pressed against a rear side of the third set of push members 10 and a rear rib portion 42 in the housing 4. The release trigger 8 is provided at a predetermined position with a cam face 81, which is in contact with a near lower front side of the second set of push members 9. The plastic cushion 11 is located between the second set of push members 9 and the third set of push members 10. Due to a specially designed shape of the plastic cushion 11 and a push force applied by the second compression spring 12 against the rear side of the third set of push members 10, the second set of push members 9 is rearward inclined while the third set of push members 10 is forward inclined, such that the through openings 90 on the rearward inclined second set of push members 9 are firmly pressed against a lower side of the scaled rod 3; and, the through opening 100 on the forward inclined third set of push members 10 are firmly pressed against an upper side of the scaled rod 3.

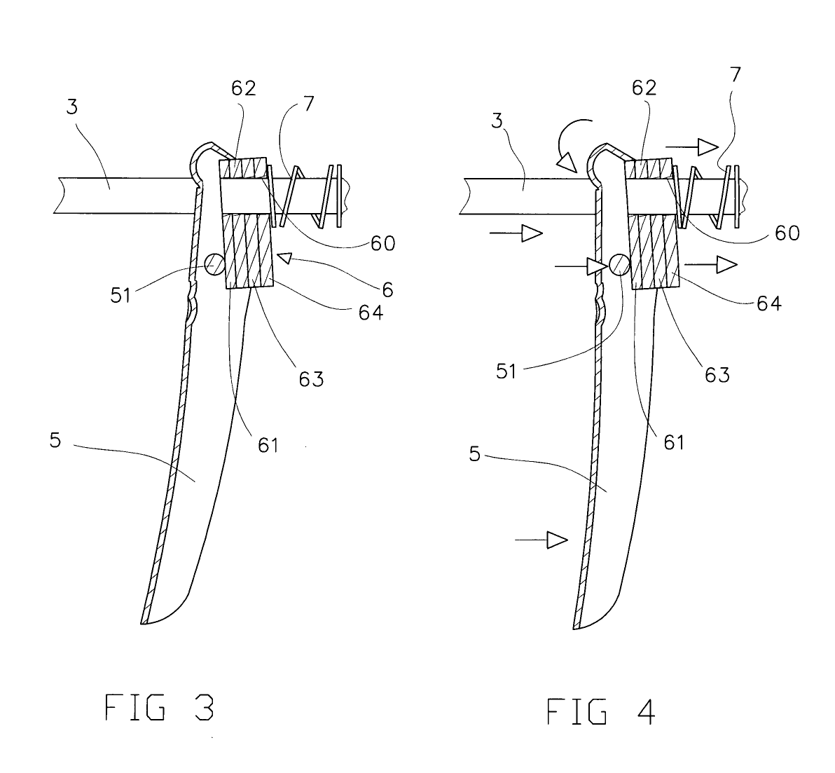

As can be clearly seen from FIGS. 3 and 4, the first set of push members 6 mounted in the front portion of the housing 4 includes total four push members 61, 62, 63, and 64. For example, when the operating handle 5 is pulled rearward to produce a clamping force of 100 kg, the force transmitted to each of the four push members 61, 62, 63, and 64 is 25 kg. With this arrangement, the applied force transmitted to the four push members is optimally buffered, and an operator needs only to apply a largely reduced force to rearward pull the operating handle 5 for the connecting link 51 to rearward push the first set of four push members 61, 62, 63, 64 and thereby compress the first compression spring 7. At this point, the through openings on the inclined push members 61, 62, 63, 64 firmly pressed against the scaled rod 3 will bring the scaled rod 3 to move rearward along with the first set of four push members 6. And, when the operating handle 5 is released, an elastic restoring force of the compressed first compression spring 7 automatically pushes the operating handle 5 and the four push members 61-64 to their original positional state. That is, the clamping device may be operated with largely reduced effort to firmly clamp a workpiece.

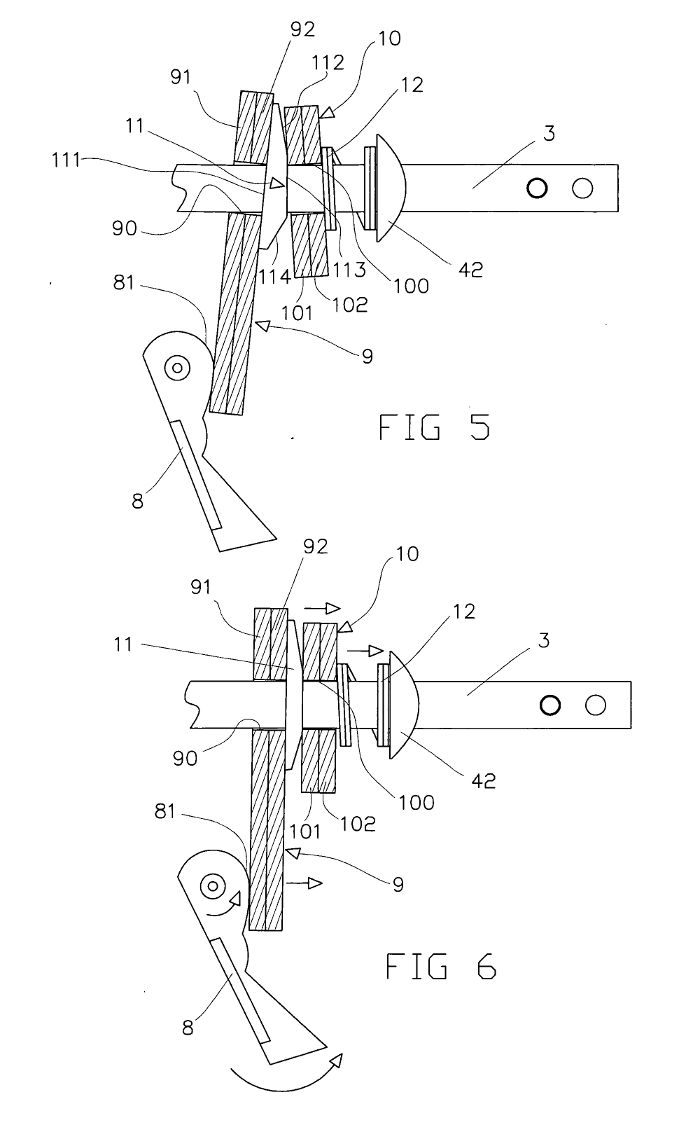

As can be clearly seen from FIGS. 5 and 6, the second set of push members 9 and the third set of push members 10 mounted in the rear portion of the housing 4 respectively include two push members 91, 92 and 101, 102. Therefore, total four push members 91, 92, 101, 102 are also arranged in the rear portion of the housing 4. The push members 91, 92 are located before the push members 101, 102, and the plastic cushion 11 is located between the push members 92 and 101. The plastic cushion 11 has a front side defining a straight plane 111, and a rear side defining from top to bottom three continuous tangential planes 112, 113, 114, such that the push members 91, 92 and the push members 101, 102 normally pushed forward by the second compression spring 12 are rearward and forward inclined, respectively, relative to the scaled rod 3. The through openings 90 on the rearward inclined second set of push members 91, 92 are firmly pressed against the lower side of the scaled rod 3, and the through openings 100 on the forward inclined third set of push members 101, 102 are firmly pressed against the upper side of the scaled rod 3.

When it is desired to release the scaled rod 3 from the through openings 90, 100 on the inclined push members 91, 92 and 101, 102, simply depress the release trigger 8 for the cam face 81 to turn upward and thereby rearward push the near lower side of the push members 91, 92. The push members 91, 92 in turn rearward push the plastic cushion 11 and accordingly, the push members 101, 102, so that the second compression spring 12 is compressed. At this point, the through openings 90, 100 on the push members 91, 92 and the push members 101, 102, are released from the inclined position and no longer firmly pressed against the lower and the upper side of the scaled rod 3, allowing the scaled rod 3 and accordingly, the movable jaw 1 to shift as desired. When the scaled rod 3 and the movable jaw 1 have been synchronously shifted to a desired position, the operator needs only to release the release trigger 8. At this point, the elastic restoring force of the second compression spring 12 automatically pushes the release trigger 8 and the four push members 91, 92, 101, 102 to their respective original positional state.

What is claimed is:

1. A transmission mechanism for clamping device, the clamping device including a movable jaw, a fixed jaw, a scaled rod, and a housing; the transmission mechanism comprising an operating handle, a first set of four push members, a first compression spring, a release trigger, a second set of two push members, a plastic cushion, a third set of two push members, and a second compression spring.

2. The transmission mechanism for clamping device as claimed in claim 1, wherein the movable jaw is fastened to a free end of the scaled rod using a screw bolt.

3. The transmission mechanism for clamping device as claimed in claim 1, wherein the operating handle, the first set of four push members, and the first compression spring are mounted in a front side of the housing; and the release trigger, the second set of two push members, the plastic cushion, the third set of two push members, and the second compression spring are mounted in a rear side of the housing.

4. The transmission mechanism for clamping device as claimed in claim 3, wherein the operating handle and the second set of four push members are provided with a through opening each, via which the scaled rod is extended to assemble to the operating handle and the first set of four push members; the first set of four push members is located behind the operating handle, the first compression spring is mounted around the scaled rod with two ends separately pressing against a rear side of the first set of four push members and a front rib portion in the housing; and a connecting link provided on the operating handle is in contact with a front side of the first set of four push members.

5. The transmission mechanism for clamping device as claimed in claim 4, wherein the first compression spring normally pushes against the rear side of the first set of four push members, such that the first set of four push members is inclined, bringing the through openings thereof to incline and thereby firmly press against the scaled rod.

6. The transmission mechanism for clamping device as claimed in claim 3, wherein the release trigger, the second set of two push members, the plastic cushion, and the third set of two push members are provided with a through opening each, via which the scaled rod is extended to assemble to the release trigger, the second set of two push members, the plastic cushion, and the third set of two push members; the second and the third set of two push members are located behind the release trigger; the second compression spring is mounted around the scaled rod with two ends separately pressed against a rear side of the third set of two push members and a rear rib portion in the housing; a cam face formed on the release trigger is in contact with a near lower front side of the second set of two push members; and the plastic cushion is located between the second and the third set of push members.

7. The transmission mechanism for clamping device as claimed in claim 6, wherein, due to a specially designed shape of the plastic cushion and an elastic force forward applied by the second compression spring against the rear side of the third set of two push members, the second set of two push members is rearward inclined while the third set of two push members is forward inclined, bringing the through openings formed thereon to incline and thereby firmly press against lower and upper sides of the scaled rod, respectively.

8. The transmission mechanism for clamping device as claimed in claim 7, wherein the plastic cushion has a front side defining a straight plane, and a rear side defining from top to bottom three continuous tangential planes.
